(19) United States
(12) Patent Application Publication
(10) Pub. No.: US 2007/0032127 A1
(43) Pub. Date: Feb. 8, 2007

(54) Method and apparatus for saving volatile memory settings in a vehicle

(75) Inventor: Robert Charles Sheppard, Westlake, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/196,766

(22) Filed: Aug. 4, 2005

(51) Int. Cl. H01R 11/00

(52) U.S. Cl. 439/502

(57) ABSTRACT

A cable is provided that may be used to provide an alternate source of voltage of a vehicular electrical system when the main battery of a vehicle is removed. The cable typically makes use of the battery or battery pack of a hand-held cordless power tool to provide the voltage. Also, the cable is typically electrically connected to the vehicle through the cigarette lighter outlet or through the j1962 connector of the vehicle. Also, a method of using the cable to preserve volatile memory data in a vehicle when the vehicle's main battery is removed.

### FIELD OF THE INVENTION

The present invention relates generally to methods of saving volatile memory settings in a vehicle. The present invention also relates generally to devices and apparatuses for implementing such methods.

### BACKGROUND OF THE INVENTION

Periodically, the main batteries of cars, trucks, boats and other vehicles need to be replaced. Unfortunately, when removing a main battery from a vehicle, all of the vehicle's electrical systems typically lose power and become inoperable. As such, all of the volatile memory included in the electrical systems of the vehicle gets reset and all user-defined and preset values stored in the volatile memory are lost once a new main battery is in place. In many vehicles, this means that all digital radio settings, cellular phone settings, keyless entry codes and anti-theft systems are reset to default values.

A device does exist that eliminates the inconvenience of a vehicle owner having to reset all user-defined and preset values stored in the volatile memory of a vehicle when the main battery is replaced. This device provides an alternate source of voltage when a the vehicle's main battery is being replaced. More specifically, this device includes a vehicular interface that is configured to be connected to the cigarette lighter outlet of a vehicle, a battery interface that is configured to be connected to a 9 V battery and a cord that electrically connects the battery interface to the vehicular interface. In use, the vehicular interface is plugged into the cigarette lighter outlet of the vehicle and a 9V battery is electrically connected to the battery interface. Then, when the main battery of the vehicle is removed from the vehicle, the 9V battery provides sufficient voltage to the vehicle's electrical systems through the cigarette lighter outlet to preserve the data in the vehicle's volatile memory.

An alternate device also exists where, again, a vehicular interface is configured to be plugged into the cigarette lighter outlet of a vehicle. This alternate device also includes a cord providing an electrical connection between the vehicular interface and a battery interface. However, instead the battery interface being configured to accommodate a 9V battery being electrically connected thereto, the battery interface is configured to accommodate the connection of a much larger battery, such as a motorcycle battery. In this alternate device, the larger motorcycle battery provides voltage to the vehicle's electrical system and preserves the volatile memory therein.

Unfortunately, in the first of the above-discussed devices, the 9V battery does not always provide adequate voltage to properly ensure that all of the data stored in the volatile memory will be preserved. In the above-discussed alternate device, the motorcycle battery often inconvenient to use in view of its size and weight and is also expensive and not always readily available, even in garages where a vehicle is typically serviced.

At least in view of the above, it would be beneficial to provide new devices and/or methods for preserving data in a vehicle's volatile memory that neither rely upon relatively low-voltage 9V batteries nor upon relatively inconvenient, expensive and sometimes unavailable motorcycle batteries. In other words, it would be beneficial to provide new devices and methods that rely on larger batteries that are more readily available around a garage or machine shop where the main batteries of vehicles are often replaced. It would also be desirable to provide devices and/or methods that allow for connections to be made to a vehicle at a location other than a cigarette lighter outlet.

### SUMMARY OF THE INVENTION

The foregoing needs are met, to a great extent, by the present invention, wherein, in one aspect thereof, a cable is provided. The cable includes a first adapter configured to be electrically connected to a cordless power tool battery. The cable also includes a cord connected at a first end thereof to the first adapter. The cable further includes a second adapter that is connected to a second end of the cord and that is configured to be electrically connected to a vehicle.

According to another embodiment of the present invention, a method of saving volatile memory settings in a vehicle is provided. The method includes attaching a first adapter to a cordless power tool battery. The method also includes attaching a second adapter to a vehicle, wherein the second adapter is electrically connected to the first adapter. The method further includes supplying voltage from the cordless power tool battery to the vehicle through the first adapter and through the second adapter.

According to yet another embodiment of the present invention, another cable is provided. The cable includes a first adapter configured to be electrically connected to a voltage source. The cable also includes a cord connected at a first end thereof to the first adapter. The cable further includes a second adapter connected to a second end of the cord and configured to be electrically connected to a j1962 connector of a vehicle and to transfer power from the voltage source to the vehicle.

According to still another embodiment of the present invention, yet another cable is provided. The cable includes first connecting means for electrically connecting to a cordless power tool battery. The cable also includes second connecting means for electrically connecting to a j1962 connector of a vehicle. The cable further includes third connecting means for connecting the first connecting means and the second connecting means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view of a cable according to a first embodiment of the present invention;

FIG. 2 is a front view of the dashboard of a vehicle that may be used in conjunction with devices and/or methods according to the present invention; and

FIG. 3 is a flowchart illustrating steps that may be followed in accordance with a method of saving volatile memory settings in a vehicle according to another embodiment of the present invention.

### DETAILED DESCRIPTION

At least in view of the above shortcomings of the prior art, novel devices and methods of saving volatile memory settings in a vehicle have been developed. Embodiments of the present invention will now be described with reference to the drawing figures, in which like reference numerals refer to like parts throughout.

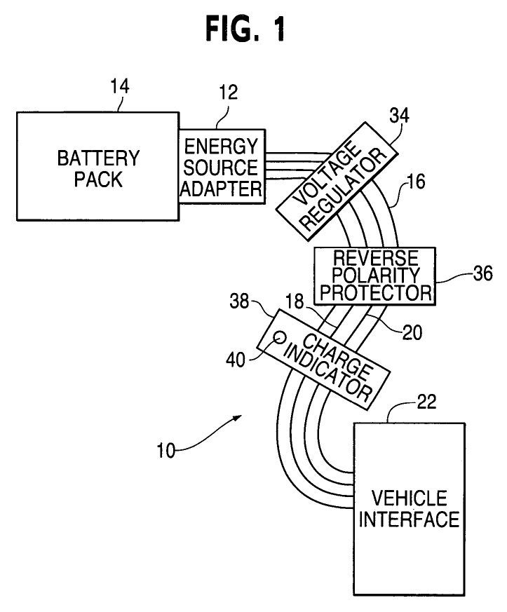

FIG. 1 is a schematic view of a cable 10 according to a first embodiment of the present invention. The cable 10 illustrated in FIG. 1 includes an energy source adapter 12 that is configured to be electrically connected to a voltage source 14. The voltage source 14 illustrated in FIG. 1 takes the form of a cordless power tool battery. According to certain embodiments of the present invention, the voltage source 14 is a battery pack that is either included in or that has been removed from a cordless drill, such as a Makita cordless impact drill. However, batteries and battery packs from other hand-held cordless tool are also within the scope of the present invention, as are other types of voltage sources, such as 9V batteries, motorcycle batteries, car batteries and boat batteries.

According to certain embodiments of the present invention, the energy source adapter 12 is configured to be electrically connected to at least one of an 18.8 V cordless power tool battery pack or a 14 V cordless power tool battery pack. However, batteries and battery packs having alternate voltages are also within the scope of the present invention.

Physically and electrically connected to the energy source adapter 12 illustrated in FIG. 1 is a cord 16. The cord 16 typically includes at least a first wire 18 and a second wire 20. No particular dimensional, geometric or materials restrictions are placed on either of the wires 18, 20. For example, wires commonly found in household lamp cords may be used as the wires 18, 20 illustrated in FIG. 1. In other words, zip cord wires may be used for one or each of the wires 18, 20 illustrated in FIG. 1. Also, it should be noted that, according to certain embodiments of the present invention, one of the wires 18, 20 goes to ground.

In FIG. 1, the energy source adapter 12 is illustrated as being connected at a first end of the cord 16 and a vehicle interface 22 is illustrated as being connected at a second and opposite end of the cord 16. The vehicle interface 22, according to certain embodiments of the present invention, takes the form of an adapter that is configured to be electrically and/or physically connected to a vehicle such as a car, truck, boat, motorcycle, all-terrain vehicle, etc.

A voltage regulator 34 is also illustrated as being part of the cable 10 in FIG. 1. The voltage regulator 34 is physically and electrically connected to the energy source adapter 12 via a portion of the cord 16. Although the voltage regulator 34 is illustrated as being adjacent to the energy source adapter 12, according to other embodiment of the present invention, the voltage regulator 34 may be positioned anywhere along the cable 10.

As will be appreciated by one of skill in the art of the present invention, the electrical systems of a vehicle to which the cable 10 is electrically connected are typically designed to operate at a particular voltage level. Since the voltage source 14 can include any of a variety of above-discussed batteries and battery packs, the voltage source 14 may not have a voltage that is directly compatible with the voltage level of the electrical systems of the vehicle. Therefore, the voltage regulator 34 illustrated in FIG. 1 is typically configured to regulate the voltage level of the voltage source 14 such that there is a match between the voltage level at the vehicle interface 22 and the operating voltage of electrical systems in the vehicle. According to certain embodiments of the present invention, the voltage regulator 34 regulates this voltage level to be approximately 12 V.

A reverse polarity protector 36 is also illustrated in FIG. 1 as being included in the cable 10. Although the reverse polarity protector 36 is illustrated in FIG. 1 as being electrically and physically connected next to the voltage regulator 34 in the cord 10, the reverse polarity protector 36 may be positioned at any location in the cable 10. Typically, the reverse polarity protector 36 is used to ensure that accidental improper connection of the energy source adapter 12 to the voltage source 14 does not adversely affect the electrical systems of the vehicle to which the cable 10 is attached. In other words, the reverse polarity protector 36 protects electrical systems in the vehicle from a technician accidentally connecting the energy source adapter 12 to the wrong leads of the voltage source 14.

A charge indicator 38 is also illustrated in FIG. 1 as being electrically and physically connected to the energy source adapter 12 and as being positioned adjacent to the reverse polarity protector 36. However, the charge indicator may be included anywhere on cable 10.

The charge indicator 38 illustrated in FIG. 1 includes a light 40. However, an LED or other indicator may be used instead of or in addition to the light 40. Typically, the light 40 informs a user of the cable 10 of whether the cable 10 has a residual charge stored therein. The charge indicator 38 may be particularly useful to prevent arcing between the vehicle interface 22 and the electrical system of the vehicle to which the cable 10 is connected or between the energy source adapter 12 and the voltage source 14.

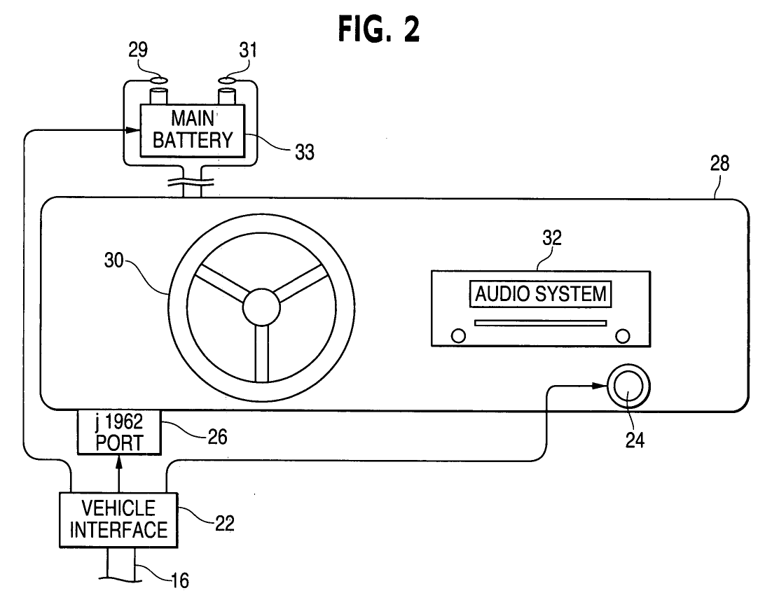

FIG. 2 is a front view of a dashboard 28 of a vehicle that may be used in conjunction with devices and/or methods according to the present invention. The dashboard 28 includes a cigarette lighter outlet 24, a j1962 port 26, a steering wheel 30 and an audio system 32. According to certain embodiments of the present invention, the vehicle interface 22 is configured to be electrically and/or physically connected to either the cigarette lighter outlet 24 or the j1962 port 26 illustrated in FIG. 2.

Cigarette lighter outlets have standardized geometries and electrical configurations across a wide variety of vehicle types. Therefore, any commercially-available cigarette lighter outlet interface may be used as the vehicle interface 22 or as a part thereof. j1962 connectors are standardized according to Society of Automotive Engineers (SAE) specifications. Therefore, any commercially-available j1962 interface may be used as the vehicle interface 22 or as a part thereof. However, alternate designs of the vehicle interface 22 that will become apparent to one of skill in the art upon practicing an embodiment of the present invention are also within the scope of the present invention.

As illustrated in FIG. 2, in addition to being configured to be used in conjunction with a cigarette lighter outlet 24 or a j1962 port 26, the vehicle interface 22 may also be configured to be physically and/or electrically connected to one or more leads 29, 31 that are commonly used to connect the main battery 33 of a vehicle to the electrical systems of the vehicle. Also, according to other embodiments of the present invention, the vehicle interface 22 may be configured to be electrically and/or physically connected to the electrical systems of the vehicle at another location that is either on or in the vehicle.

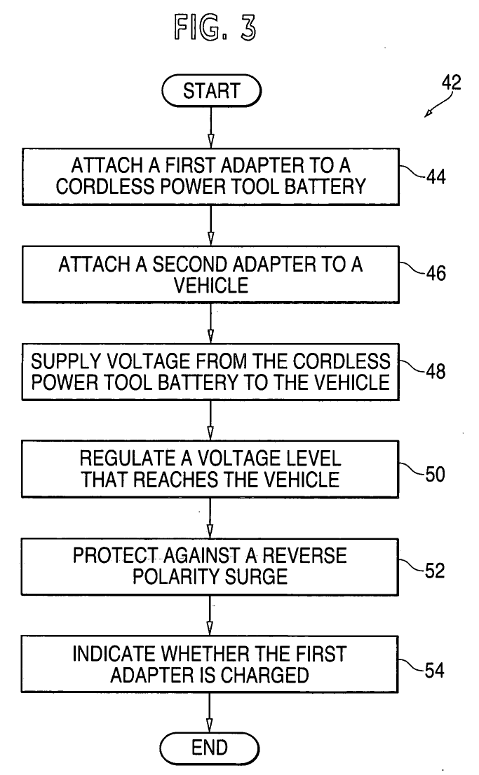

FIG. 3 is a flowchart 42 illustrating steps that may be followed in accordance with a method of saving volatile memory settings in a vehicle according to another embodiment of the present invention. The steps in the flow chart 42 may be used, for example, to preserve radio presets, seat settings, vehicle computer memory, etc.

The first step 44 in the flowchart 42 includes attaching a first adapter to a cordless power tool battery. If the method illustrated in the flowchart 42 is implemented using the cable 10 illustrated in FIG. 1, the first step 44 may be implemented by attaching the energy source adapter 12 to a voltage source 14 that takes the form of a hand-held power tool battery or battery pack. However, according to alternative embodiments of the present invention, a voltage source other than a power tool battery or battery pack may also be used (e.g., a 9V battery or a motorcycle battery).

The second step 46 of the flowchart 42 includes attaching a second adapter to a vehicle. The second step 46 also includes that the second adapter should be electrically connected to the first adapter. The second step 46 may be implemented using the cable 10 illustrated in FIG. 1 by connecting the vehicle interface 22 to the energy source adapter 12 via the cord 16. However, other ways of connecting a second adapter to a first adapter are also within the scope of the present invention.

The third step 48 illustrated in the flowchart 42 includes supplying a voltage from the cordless power tool battery or battery pack to the vehicle through the first adapter and the second adapter. One of skill in the art will appreciate that the third step 48 may be implement using the cable 10 illustrated in FIG. 1 by attaching a voltage source 14 to the energy source adapter 12 and by allowing electricity to flow between the voltage source 14 and whatever component of the vehicle the vehicle interface 22 is electrically and/or physically connected to. For example, electricity from the voltage source 14 may flow through the cigarette lighter outlet 24 or j 1962 port 26 illustrated in FIG. 2. Alternatively, the flow of electricity may be through leads to the main battery of the vehicle.

The fourth step 50 of the flowchart 42 includes regulating a voltage level that reaches the vehicle with a voltage regulator electrically connected between the cordless power tool battery or battery pack and the vehicle. In the cable 10 illustrated in FIG. 1, the voltage regulator 34 may be used to implement the fourth step 50.

According to certain embodiments of the present invention, the voltage is regulated according to the fourth step 50 to match the operating voltage of electrical systems of the vehicle to which the cable 10 is electrically connected. Often, this voltage level is approximately 12 volts. However, other voltage levels are also within the scope of the present invention.

The fifth step 52 of the flowchart 42 includes protecting against a reverse polarity surge using a reverse polarity protector that is electrically connected between the cordless power tool battery or battery pack and the vehicle. The reverse polarity protector 36 illustrated in FIG. 1 may be used to implement the fifth step 52 of the flowchart 42 and can avoid adverse effects to the electrical systems of the vehicle if the energy source adapter 12 is inadvertently improperly connected to the voltage source 14.

The sixth step 54 of the flowchart 42 includes indicating whether the first adapter is charged. This indication comes from a charge indicator that is electrically and/or physically connected between the hand-held cordless power tool battery or battery pack and the vehicle. Referring to FIG. 1, the charge indicator 38 illustrated therein may be used to implement the sixth step 54 of the flowchart 42.

According to certain embodiments of the present invention, when any part of the cable 10 is charged, the light 40, or an LED or other indicator device, turns on. This alerts a potential user of the cable 10 that arcing may result if the cable 10 is place in close proximity to either a charged voltage source 14 or a charged electrical system of a vehicle.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A cable, comprising:
a first adapter configured to be electrically connected to a cordless power tool battery;
a cord connected at a first end thereof to the first adapter; and
a second adapter connected to a second end of the cord and configured to be electrically connected to a vehicle.

2. The cable of claim 1, wherein the second adapter is configured to be electrically connected to a cigarette lighter outlet of the vehicle.

3. The cable of claim 1, wherein the second adapter is configured to be electrically connected to a j1962 connector of the vehicle.

4. The cable of claim 1, wherein the second adapter is configured to be electrically connected to a lead to a main battery of the vehicle.

5. The cable of claim 1, wherein the first adapter is configured to be electrically connected to at least one of an 18.8 V cordless power tool battery or a 14 V cordless power tool battery.

6. The cable of claim 1, further comprising:
a voltage regulator electrically connected to the first adapter and configured to regulate a voltage level that reaches the vehicle.

7. The cable of claim 1, further comprising:
a reverse polarity protector electrically connected to the first adapter.

8. The cable of claim 1, further comprising:
a charge indicator electrically connected to the first adapter.

9. The cable of claim 1, wherein the cord comprises a first wire and a second wire.

10. The cable of claim 9, wherein the first wire is a zip cord wire.

11. A method of saving volatile memory settings in a vehicle, the method comprising:
attaching a first adapter to a cordless power tool battery;
attaching a second adapter to a vehicle, wherein the second adapter is electrically connected to the first adapter; and
supplying voltage from the cordless power tool battery to the vehicle through the first adapter and the second adapter.

12. The method of claim 11, wherein the supplying step comprises:
electrically connecting the second adapter to a cigarette lighter outlet of the vehicle.

13. The method of claim 11, wherein the supplying step comprises:
electrically connecting the second adapter to a j1962 connector of the vehicle.

14. The method of claim 11, further comprising:
regulating a voltage level that reaches the vehicle with a voltage regulator electrically connected between the cordless power tool battery and the vehicle.

15. The method of claim 11, further comprising:
protecting against a reverse polarity surge using a reverse polarity protector electrically connected between the cordless power tool battery and the vehicle.

16. The method of claim 11, further comprising:
indicating whether the first adapter is charged using a charge indicator electrically connected between the cordless power tool battery and the vehicle.

17. A cable, comprising:
a first adapter configured to be electrically connected to a voltage source;
a cord connected at a first end thereof to the first adapter; and
a second adapter connected to a second end of the cord and configured to be electrically connected to a j1962 connector of a vehicle and to transfer power from the voltage source to the vehicle.

18. The cable of claim 17, further comprising:
a voltage regulator electrically connected to the first adapter and configured to regulate a voltage level that reaches the vehicle.

19. The cable of claim 17, further comprising:
a reverse polarity protector electrically connected to the first adapter.

20. A cable, comprising:
first connecting means for electrically connecting to a cordless power tool battery;
second connecting means for electrically connecting to a j1962 connector of a vehicle; and
third connecting means for connecting the first connecting means and the second connecting means.

21. The cable of claim 20, further comprising:
voltage regulating means for matching a first voltage from the cordless power tool battery and a second voltage level of an electrical system in the vehicle, wherein the voltage regulating means is electrically connected to the first connecting means.
